(19) United States
(12) Patent Application Publication
(10) Pub. No.: US 2014/0172454 A1
(43) Pub. Date: Jun. 19, 2014

(54) METHODS AND SYSTEMS FOR SCHEDULING, TRACKING, RECORDING AND MONITORING INFUSION ROOM ACTIVITY

(71) Applicant: Institute for Cancer Research d/b/a The Research Institute of Fox Chase Cancer Center, (US)

(72) Inventor: Mark Andrew Siemon, Cheltenham, PA (US)

(73) Assignee: Institute for Cancer Research d/b/a The Research Institute of Fox Chase Cancer Center, Philadelphia, PA (US)

(21) Appl. No.: 13/802,988

(22) Filed: Mar. 14, 2013

Related U.S. Application Data
(60) Provisional application No. 61/737,457, filed on Dec. 14, 2012.

(51) Int. Cl. G06F 19/00

(52) U.S. Cl. CPC G06F 19/327
USPC 705/3

(57) ABSTRACT

A method and system for scheduling, tracking, recording, and monitoring of patients' usage of an infusion room, along with various tools to analyze the infusion room activity, to thereby improve usage of the infusion room, and improve patient satisfaction relating to their infusion room experience, is disclosed. The inventive methods and systems use real-time computer processors, software, and distributed sensors to monitor, record, analyze, and graphically display relevant infusion room chair status, patient status, and patient medical condition while in the infusion room. In preferred embodiments, the inventive methods and systems provide real-time input capability for medical personnel, and real-time automatic data output for use by or to prompt medical personnel. The inventive methods and systems are capable of recording activity of the infusion room to permit later analysis, modeling, and simulation to allow for improvements in infusion room efficiencies and patient satisfaction.

### CROSS REFERENCE TO RELATED APPLICATIONS

This application claims priority to U.S. Provisional Application No. 61/737,457, filed on Dec. 14, 2012, the contents of which are incorporated by reference herein, in their entirety and for all purposes.

### FIELD OF THE INVENTION

The present invention relates generally to methods and systems for monitoring and managing usage of facilities, and in more particularity, to systems for managing patients use of medical facilities. More specifically, the present invention relates to methods and systems for scheduling, tracking, recording and monitoring the use of infusion room facilities by patients.

### BACKGROUND OF THE INVENTION

Infusion therapy involves the administering of medications to a patient intravenously through a needle or catheter. Such medication administration is often required when oral dosage or usage of the medication is not fully effective. Infusion rooms have been created and used in hospitals and other medical facilities for many years to allow patients the ability to have the intravenous medications administered in a controlled setting, and where the setting may be more aligned as an out-patient environment.

A typical infusion room is designed to centralize and process multiple patients at a given time to improve efficiencies of administering the medications, along with improving the efficient usage of the medical facility's personnel and infrastructure. However, as is true with most medical facilities, and the administering of medical assistance, such medical care is highly dependent upon, the availability of medical personnel and availability and preparation of the necessary medications, and more importantly the varying needs and medical condition of the patient. Indeed, the scheduling and tracking of patients within an infusion room setting presents unique and challenging problems.

By way of example of certain of those problems, the flow of multiple patients through an infusion room is dependent upon several elements, including at least: (a) availability of specially trained medical personnel, including nurses; (b) availability of open infusion chairs for each patient; (c) availability and preparation of the particular and expensive medications; (d) timely operation of the supporting laboratory facility (relating to the patient's medications and blood work); and (e) availability of physician's to review the patient's records and medical condition. Medical personnel who work in infusion rooms, and patients (and family) who need to be at an infusion room fully understand that the flow and schedule of patients through the infusion room may be completely, and dynamically altered as a function of many variables, including patient blood test results, patient care needs that arise during the infusion treatment, and/or the evaluation of medical personnel relating to the patient's reaction and condition as a result of the infusion treatment. If the infusion room operations are inefficiently managed, there is a direct financial impact on the costs of operating such facilities.

In addition to identification of any system efficiencies, medical facilities and medical personnel at those facilities are always aware of, and seek to improve patient satisfaction relating to the patient's time in the infusion room. Any delays or apparent disorganization are important factors in a patient being dissatisfied with his or her exposure to the infusion room setting.

While it is often easy to see that an infusion room is crowded and certain patients are not moving through their treatments quickly, or that certain medication or medical personnel resources are not immediately available, the identification of the sources for any such delays or resources issues, is very difficult, especially given the dynamic nature of the infusion room operations. What is needed is a method and system to, in real-time, schedule, track, record, and monitor infusion room operations and activity. Such methods and systems would be able to provide efficiently intake patients; schedule the patients for infusion room activity; track the status of each patient within the infusion room, including medical condition of the patient; record all such activity and operations, and provide input and output means for input and monitoring of the infusion room operations. The disclosed methods and systems provide such a solution to the above noted problems.

### SUMMARY OF THE INVENTION

The primary aspects and elements of the inventive infusion room operations manager methods and systems are for scheduling, tracking, recording, and monitoring of patients' usage of an infusion room. Moreover, the inventive methods and systems include sophisticated tools to allow analysis of the infusion room activity, to then permit implementation of improvements for usage of the infusion room, and thereby improve patient satisfaction relating to their infusion room experience.

The inventive methods and systems use real-time computer processors, software, and distributed sensors to record, analyze, and graphically display relevant infusion room chair status, patient status, and patient medical condition. In preferred embodiments, the inventive methods and systems provide real-time input capability for medical personnel, and real-time automatic data output for use by or to prompt medical personnel. The inventive methods and systems are capable of recording activity of the infusion room to permit later analysis, modeling, and simulation to further improve infusion room efficiencies and patient satisfaction.

The present invention overcomes the disadvantages of the prior art and fulfills the needs described above by providing a method for finding expertise based on user customizable search and ranking parameters, and providing the search results at a person or expert level.

More specifically, a preferred embodiment of the present invention is a computerized method for scheduling, tracking, recording, and monitoring of activity and patients' usage of an infusion room, using at least one computer processor, a plurality of data bases stored in the at least one computer processor; a plurality of infusion room seats in two-way communication with said at least one computer processor; and a plurality of input/output devices in two-way communication with said at least one computer processor; wherein said at least one computer processor executes the steps comprising of (a) monitoring the usage of each of said plurality of infusion room seats; (b) monitoring the status of each patient using each of said plurality of infusion room seats; (c) receiving input from said plurality of input/output devices entered by medical personnel; (d) storing and updating monitored patient status information in said plurality of data bases; (e) storing input/output device display information in said plurality of data bases; and (f) transmitting output data to said plurality of input/output devices to be viewed by medical personnel.

In another preferred embodiment, the present invention is a computer-based system for scheduling, tracking, recording, and monitoring of activity and usage of an infusion room, comprising at least one computer processor; a plurality of data bases stored in the at least one computer processor; a plurality of infusion room seats in two-way communication with said at least one computer processor; and a plurality of input/output devices in two-way communication with said at least one computer processor; wherein said at least one computer processor (a) monitors the usage of each of said plurality of infusion room seats; (b) monitors the status of each patient using each of said plurality of infusion room seats; (c) receives input from said plurality of input/output devices entered by medical personnel; (d) stores and updates monitored patient status information in said plurality of data bases; (e) stores input/output device display information in said plurality of data bases; and (f) transmits output data to said plurality of input/output devices to be viewed by medical personnel.

Other features and advantages of the present invention are provided in the following detailed description of the invention, which refers to the accompanying drawings.

### BRIEF DESCRIPTION OF THE DRAWINGS

The drawings and figures, which form a part of this specification, include the following:

FIG. 1 illustrates an architecture for a preferred embodiment of the inventive infusion room operations manager;

FIG. 2 illustrates an exemplary embodiment of an input/output display for the inventive infusion room operations manager showing patient location, seat availability, and patient status;

FIG. 3 illustrates an exemplary embodiment of an input/output display for the inventive infusion room operations manager showing further detail of a particular patient and timing details for that patient in the infusion room;

FIG. 4 illustrates an exemplary embodiment of an input/output display for the inventive infusion room operations manager showing blood work details of a particular patient, linked from a prior output display for a patient in the infusion room; and

FIG. 5 illustrates an exemplary embodiment of an input/output display for the inventive infusion room operations manager for access to files for retrieving patient information, and inputting operations information relating to the infusion room.

### DETAILED DESCRIPTION OF PREFERRED EMBODIMENTS OF THE INVENTION

The present invention provides example methods and systems for improving the operation and management of one or more medical infusion rooms. The primary attributes of the inventive infusion room operations manager methods and systems are to provide for efficient scheduling, tracking, recording, and monitoring of patients' usage of an infusion room, including usage of medical equipment and related facilities. The inventive methods and systems include sophisticated computer processing software, sensors, and related tools to allow analysis of the infusion room activity, including recorded activity. With use of such recorded usage data, infusion room managers are able to analyze how the medical facility is operated and being used, and thereby permit implementation of improvements for usage of the infusion room, and thereby improve patient satisfaction relating to their infusion room experience.

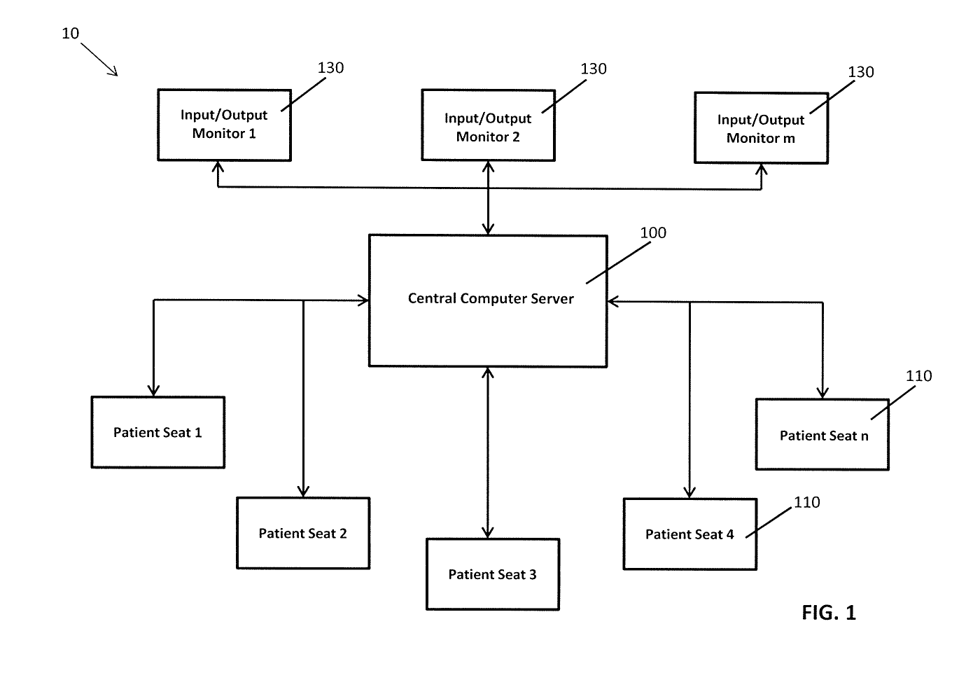

For such inventive methods and systems to be effective, the methods and systems use real-time computer processors, software, and distributed sensors to record, analyze, and graphically display relevant infusion room chair status, patient status, and patient medical condition. By way of a preferred embodiment and example, FIG. 1 illustrates a system architecture for the primary elements of the inventive infusion room operations manager 10. Such elements include one or more computer servers 100 that are in communication with a plurality of patient seats 110, and in communication with a plurality of input/output (“I/O”) displays 130. In certain embodiments the communications between the system elements can be wired, or with appropriate communication segregation, the communications between the computer servers 100, patient seats 110 and I/O displays 130 can be implemented wirelessly.

As shown in FIG. 1, the communication paths between the computer servers 100 and the patient seats 110, I/O displays 130 should provide for two-way communications. Such two-way communications between the computer servers 100 and patient seats 110 allows patient seat data to be retrieved or sensed by the computer server 100, and also permits information or data to be transmitted back to the patient seat 110 for access by a patient or medical personnel who may be with the patient or administering to activities at a particular patient seat.

An important element of the inventive methods and systems is the ability to quickly enter data and information into a central computer processor 100, and the ability for medical personnel to quickly retrieve data and information from the computer processor 100. The data entry into the central computer processor 100 can be by medical personnel or through distributed sensors located at the patient seats 110 or located otherwise within the infusion room. The data and information includes, without limitation, infusion seat 110 data (e.g., available, taken), patient data (e.g., status of infusion medication, patient blood work, any patient alerts), and/or status of laboratory results. Although not shown in FIG. 1, the central computer processor 100 may be connected to, or otherwise communicating with other servers. For example, the central computer processor 100 may be a distinct server that is connected to separate server or servers with a hospital complex.

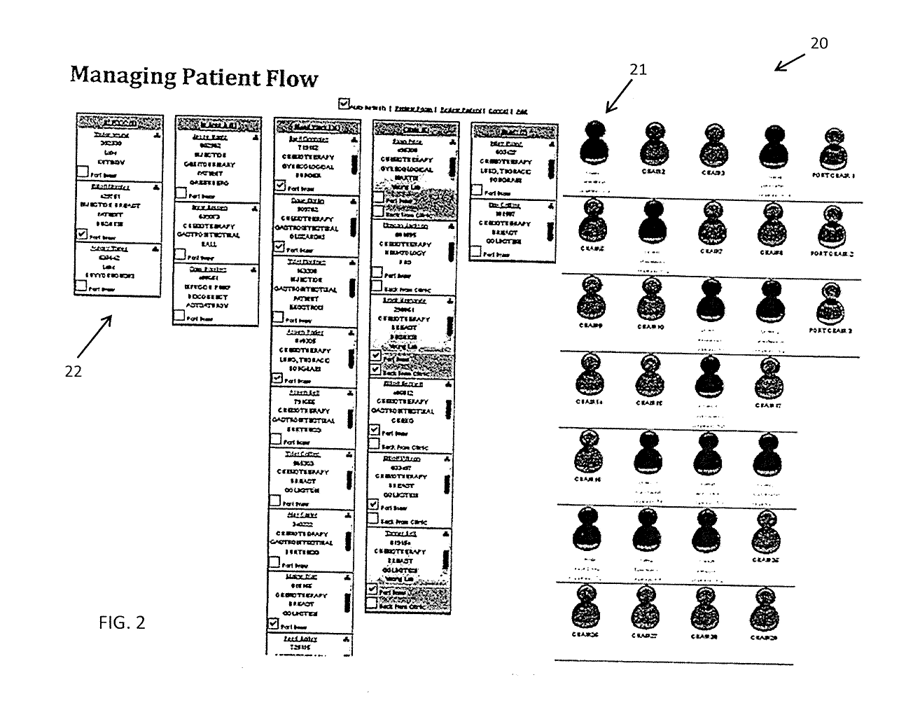

With respect to the I/O devices and displays 130, the layout for entering or displaying relevant information may be configured in any way useful for the users. An exemplary embodiment for an I/O display 130 is shown in FIG. 2. The display 20 shows data for managing patient flow through an infusion room. Infusion room chair status 21 may be shown, in color coding, as illustrated on the right hand side of FIG. 2, and patient information 22 may be shown, again in certain color coding, as illustrated on the left hand side of FIG. 2.

The exemplary display 20 shown in FIG. 2 is updated by the central computer processor 100 on a real-time basis to provide current information and data to medical personnel. The data shown in display 20 is synthesized from input received from several sources, including a scheduling system, the laboratory system, and the patient check-in system. Such systems (scheduling, laboratory, and patient check-in) may be maintained on the computer processor 100, or may be maintained on separate servers or processors, not shown in FIG. 1. If such systems are maintained on separate servers, the inventive system computer processor 100 should be in real-time two-way communication with such separate servers to ensure that the inventive methods and systems have access to the most current information.

The data shown in FIG. 2 may include by way of preferred example, the patients' identification information to show who (a) has arrived at the infusion room, (b) is waiting for laboratory test results, (c) has received their laboratory test results, (d) is waiting to see or consult with their physician, (e) has returned from seeing or consulting with their physician, and (f) is ready to be seated at an infusion room seat. As shown in FIG. 2, with the use of color coding, status information is readily and easily shown to medical personnel. For example, in a preferred embodiment, if an infusion chair is open, it may be colored blue. Once a patient is seated in a particular chair, and the data is entered in to the system (either by the medical personnel, or automatically by a seat sensor) the icon would change to red to show that that particular infusion chair is occupied and not available for a patient.

Other colors are available for other conditions. For example, if adverse reactions or emergency conditions develop for a patient while at an infusion chair, the medical personnel or nurse can indicate such conditions, which would turn the seat icon color purple to possibly advise other personnel of the condition, and possibly need for assistance. Moreover, such conditions could send separate particular alerts or alarms to ensure the patient is receiving the correct attention and care. Similarly, for a patient in an infusion seat, when the medication administration is nearing completion, for example within thirty minutes of completion, the chair icon can automatically change to orange, or some other color, and thereby advise medical personnel that the chair will be available for preparation for the next patient within a short period of time.

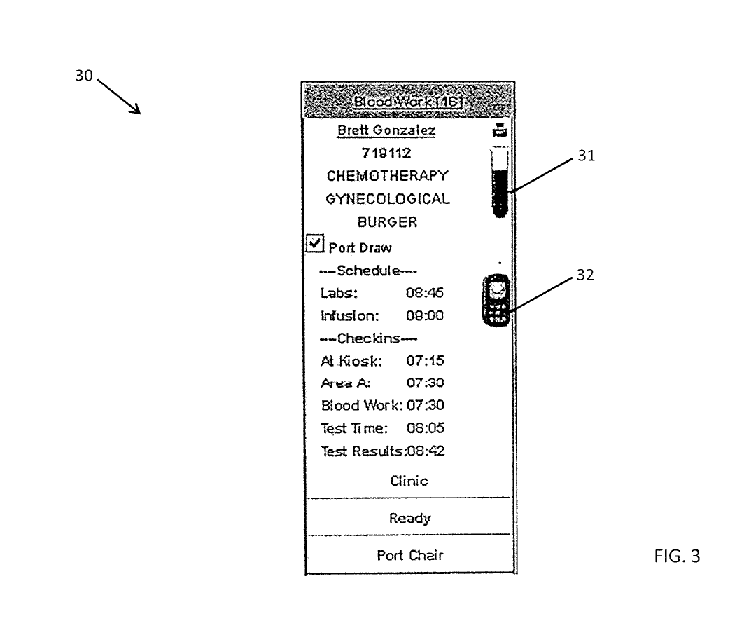

Details about the patients within the infusion room are also able to be displayed and available to medical personnel through the I/O displays 130. For example, in a preferred embodiment as shown in FIG. 2, if a particular patient icon 22 is selected, the system pulls that patient's specific data from the computer server 100, and displays such data through the I/O display 130. An exemplary embodiment of such a patient specific display 30 is shown in FIG. 3. The data shown in FIG. 3 provides the patient's scheduled times relating to his or her use of the infusion room, and also shows the actual times. By way of one example, as shown in FIG. 3, the times shown include the time the patient arrived at the kiosk, the time the patient arrived at Area A for blood work, the time blood work was initiated, the time for the patient's test, and the time for the patient's test results. Further, the display may also show the scheduled time for the patient's laboratory tests, and for actual infusion after the laboratory tests.

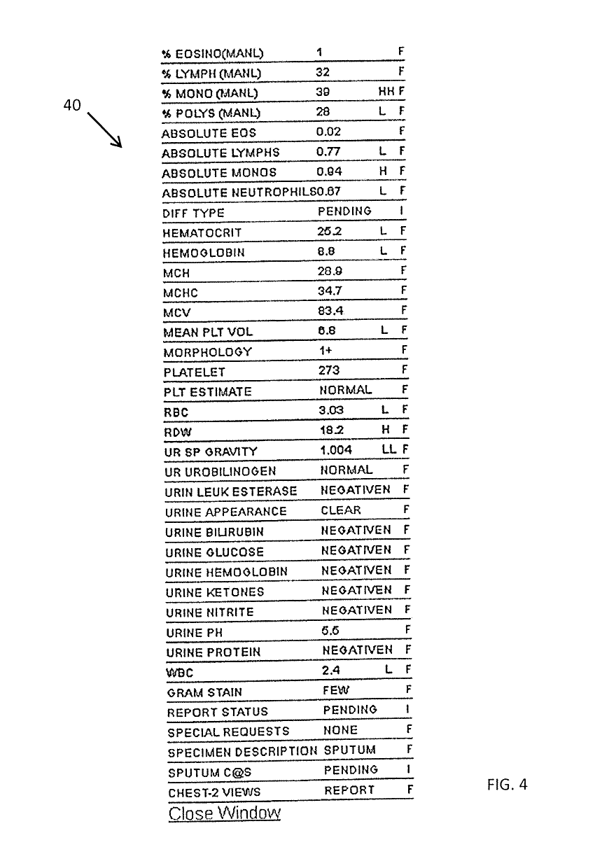

As also shown in the exemplary embodiment of FIG. 3, certain other icons can be included to permit the medical personnel to access the patient's laboratory results by tapping or selecting the test tube icon 31. By way of example, such detailed patient laboratory results 40 may be displayed as shown in FIG. 4, listing the particular blood work test results for the selected patient. If not residing within the computer processor 100, such laboratory results may be automatically downloaded by the computer processor 100 from the laboratory computer server. Another icon as shown in FIG. 3, a beeper 32, could be implemented to allow a nurse or medical personnel to page or talk to the patient at his or her infusion seat to check on the status of the patient. This ability to readily communicate with the patient has been shown to substantially increase the patient's level of satisfaction while in the infusion room. Knowing that someone is checking in and monitoring the patient's condition is what the patient expects and desires.

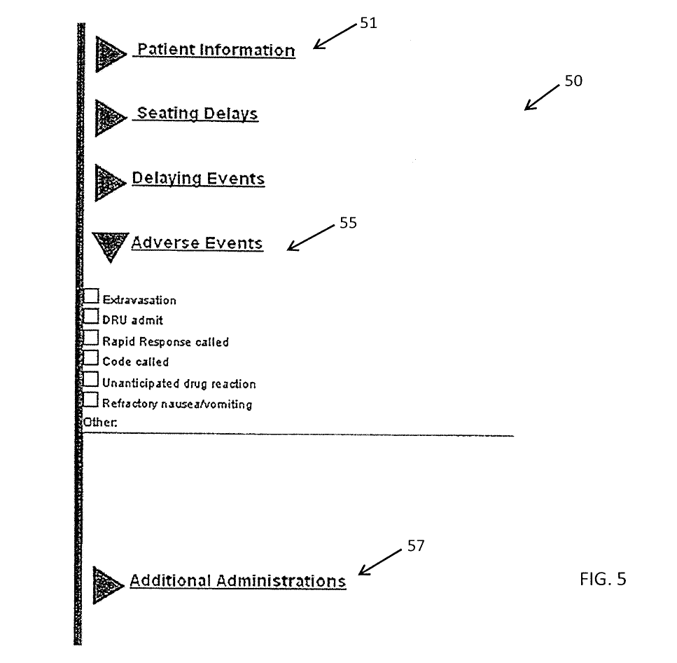

Referring back to the FIG. 2 example I/O display 20, the system allows medical personnel to enter particular data regarding a patient while the patient is being administered treatments. By touching or tapping an occupied (e.g., red) chair, particular details or patient information may be entered by the nurse or medical personnel at the I/O display 130. An exemplary display 50 for entering information, as shown in FIG. 5, may be retrieved upon touching an occupied chair. From this screen or display, the nurse may retrieve or update information about the patient through the “patient information” icon 51, or may enter information about “adverse events” by touching the “adverse events” icon 55. Similarly, other administration information may be retrieved or entered through the “additional administrations” icon 57.

As described, the infusion room operations status and patient data and information are continually being uploaded and stored at the computer processor 100. Through remote access or communication with other system servers, management or facility directors may access and observe real-time status of the infusion room at any time.

Moreover, because the infusion room operations status, and patient information is being uploaded in real-time and stored, there is the capability of re-playing or displaying the infusion activity at a later time for off-line analysis and review. Such recordings of information includes system displays such as those shown in FIGS. 2 through 5. The recorded information is maintained in a server log format so that all activity is time-stamped and readily traceable. If video recordings of the activity in the infusion room are also maintained, such video recordings can be linked with the computer processor 100 recorded data to show a visual of the infusion room activity.

Through review and analysis of the recorded data, it is possible to run simulations of infusion room activities, and thereby propose and test improvements to the system to ensure efficient use of the infusion room, and to improve patient satisfaction of their exposure to and time at the infusion room. Similarly, through analysis of the recorded data, many different reports analyzing the data can be generated. By way of example, such reports could include productivity reports for nurse practitioners; utilization reports for each infusion room chair (to possibly note equipment problems); and different average times for obtaining necessary data, including laboratory test results, and availability of medical personnel, including physicians.

While certain exemplary embodiments have been disclosed and described, there are other method variations and system configurations for infusion room scheduling, tracking, and monitoring that are equally possible using the method steps and system elements and architecture as disclosed herein. Such equivalent configurations are deemed fully within the scope of the inventive methods and systems for infusion room operations management. Those having ordinary skill in the art and access to the teachings provided herein will recognize additional modifications, applications, embodiments and substitution of equivalents all of which are within the scope of the invention. Accordingly, the invention is not to be considered as limited by the foregoing description.

What is claimed is:

1. A computerized method for scheduling, tracking, recording, and monitoring of activity and patients' usage of an infusion room, using at least one computer processor, a plurality of data bases stored in the at least one computer processor; a plurality of infusion room seats in two-way communication with said at least one computer processor; and a plurality of input/output devices in two-way communication with said at least one computer processor; wherein said at least one computer processor executes the steps comprising of:
(a) monitoring the usage of each of said plurality of infusion room seats;
(b) monitoring the status of each patient using each of said plurality of infusion room seats;
(c) receiving input from said plurality of input/output devices entered by medical personnel;
(d) storing and updating monitored patient status information in said plurality of data bases;
(e) storing input/output device display information in said plurality of data bases; and
(f) transmitting output data to said plurality of input/output devices to be viewed by medical personnel.

2. The computerized method for scheduling, tracking, recording, and monitoring of activity and patients' usage of an infusion room, according to claim 1, wherein the steps of monitoring, receiving, storing, updating and transmitting are executed in real-time.

3. The computerized method for scheduling, tracking, recording, and monitoring of activity and patients' usage of an infusion room, according to claim 1, further comprising real-time recording of all infusion room information, and storage of said recorded information in at least one of said plurality of data bases.

4. The computerized method for scheduling, tracking, recording, and monitoring of activity and patients' usage of an infusion room, according to claim 3, further comprising means to replay the real-time recordings of said infusion room information.

5. The computerized method for scheduling, tracking, recording, and monitoring of activity and patients' usage of an infusion room, according to claim 3, further comprising video recording of infusion room operations.

6. A computer-based system for scheduling, tracking, recording, and monitoring of activity and usage of an infusion room, comprising:
at least one computer processor;
a plurality of data bases stored in the at least one computer processor;
a plurality of infusion room seats in two-way communication with said at least one computer processor; and
a plurality of input/output devices in two-way communication with said at least one computer processor;
wherein said at least one computer processor
(a) monitors the usage of each of said plurality of infusion room seats;
(b) monitors the status of each patient using each of said plurality of infusion room seats;
(c) receives input from said plurality of input/output devices entered by medical personnel;
(d) stores and updates monitored patient status information in said plurality of data bases;
(e) stores input/output device display information in said plurality of data bases; and
(f) transmits output data to said plurality of input/output devices to be viewed by medical personnel.

7. The computer-based system for scheduling, tracking, recording, and monitoring of activity and usage of an infusion room, according to claim 6, wherein the steps of monitoring, receiving, storing, updating and transmitting are executed in real-time.

8. The computer-based system for scheduling, tracking, recording, and monitoring of activity and usage of an infusion room, according to claim 6, further comprising real-time recording of all infusion room information, and storage of said recorded information in at least one of said plurality of data bases.

9. The computer-based system for scheduling, tracking, recording, and monitoring of activity and usage of an infusion room, according to claim 8, further comprising means to replay the real-time recordings of said infusion room information.

10. The computer-based system for scheduling, tracking, recording, and monitoring of activity and usage of an infusion room, according to claim 6, further comprising video recording of infusion room operations.

11. The computer-based system for scheduling, tracking, recording, and monitoring of activity and usage of an infusion room, according to claim 6, wherein the two-way communication between said at least one computer processor and said plurality of infusion room seats and said plurality of input/output devices is wireless.

12. The computer-based system for scheduling, tracking, recording, and monitoring of activity and usage of an infusion room, according to claim 6, further comprising sensors at each of said plurality of infusion room seats to sense when each of said plurality of infusion room seats is occupied and in operation.

13. The computer-based system for scheduling, tracking, recording, and monitoring of activity and usage of an infusion room, according to claim 6, further comprising alert sensors at each of said plurality of infusion room seats to sense if a patient's condition needs medical attention and to transmit an alert notice to said at least one computer processor.

14. The computer-based system for scheduling, tracking, recording, and monitoring of activity and usage of an infusion room, according to claim 13, wherein said alert sensors at each of said plurality of infusion room seats further transmit an alert notice to a separate medical personal station.

15. The computer-based system for scheduling, tracking, recording, and monitoring of activity and usage of an infusion room, according to claim 6, wherein said at least one computer processor has real-time access to medical records of said patients who are using said infusion room.

16. The computer-based system for scheduling, tracking, recording, and monitoring of activity and usage of an infusion room, according to claim 6, wherein said plurality of data bases stored in the at least one computer processor maintain medical records of said patients who are using said infusion room.
